(19) United States
(12) Patent Application Publication
(10) Pub. No.: US 2010/0162963 A1
(43) Pub. Date: Jul. 1, 2010

(54) Manila clam pedigree and breeding process thereof

(75) Inventors: Xiwu Yan, Dalian (CN); Yuehuan Zhang, Dalian (CN); Zhongming Huo, Dalian (CN); Jun Liang, Dalian (CN); Feng Yang, Dalian (CN); Guofan Zhang, Dalian (CN)

Correspondence Address: ZHEN ZHENG LU, 1730 HUNTINGTON DRIVE #304, DUARTE, CA, 91010, US

(73) Assignee: Dalian Fisheries University

(21) Appl. No.: 12/344,602

(22) Filed: Dec. 29, 2008

(51) Int. Cl. A01K 61/00

(52) U.S. Cl. 119/234

(57) ABSTRACT

A process for breeding a Manila clam pedigree, includes: directively breeding present Manila clam pedigrees having different shell shapes to obtain a shell shape pedigree (A) having best phenotypic character; directively breeding the shell shape pedigrees (A) from different geographical populations to obtain a geographical population pedigree (B) having best phenotypic character; directively breeding the geographical population pedigrees (B) having different shell colors to obtain a growth shell color pedigree (C) of fastest growth and a resistance shell color pedigrees (E) of highest stress resistance; hybridizing the growth shell color pedigree (C) and the resistance shell color pedigree (E) to obtain a first hybridied pedigree (F₁) of faster growth and higher stress resistance than the present Manila clam pedigrees; and directively breeding the first hybridied pedigree (F₁) to obtain a second hybridied pedigree (F₂) maintaining faster growth and higher stress resistance than the present Manila clam pedigrees.

### BACKGROUND OF THE INVENTION

1. Field of Invention

The present invention relates to a Manila clam (Ruditapes philippinarum) pedigree, and more particularly to a Manila clam pedigree of fast growth and strong stress resistance and breeding process thereof.

2. Description of Related Arts

Manila clam (Ruditapes philippinarum) belongs to Bivalvia: Veneridae: Tapetinae: Venerupis, and is a worldwide variety which is eurythermic, euryhaline and widespread. The world produces about 2 million tons Manila clam a year, and 90% thereof come from culture, especially from culture in Chinese mainland. In 2004, China produces 2.04 million tons mudflat shellfish, in which 73% are Manila clam, taking 18.4% of Chinese marine culture. The demand of Manila clam increases every year, but the production does not satisfy the demand. Thus, Manila clam culture has great potential market value. However, due to the over fishing, natural production of Manila clam decreases each year. Serious seed shortage and trait degeneration has become the main “bottle-neck” to develop culture industry of Manila clam in China

Manila clam has various shell shapes and colors, and therefore was classified into different species by many taxonomists (Zhuang Qiqian, 2000). For a long time, people realize the polymorphism of shell colors and shapes, but rarely study the reason about the existence of polymorphism. Peignon analysed the determination mechanism of shell colors of Manila clam by hybridizing Manila clam having same shell color, and mainly studied the genetic variation of shell colors and shapes, and the principle of shell color homozygosis (Peignon, et al, 1995). Chinese researchers classified the shell colors of Manila clam by symmetry, background color, radial bands, and shell patterns, then studied the relative aspects. By directive selection and cross breeding of Manila clam pedigrees with different shell colors, selective pedigrees and hybrid pedigrees are obtained. The selective pedigrees have color strains such as two-band red clam, two-band white clam, agate-black clam, ocean-red clam, pearl-white clam, zebra clam and wave clam. And the hybrid pedigrees have colors such as black zebra, red zebra, and white zebra. Meanwhile, according to the number of lunrula, Manila clam pedigrees can be classified into wide-shell (lunrula<70)type, middle-shell (70≦lunrula≦90)type, and plate-shell (lunrula>90)type. By directive selection and cross breeding of Manila clam pedigrees with different shell shapes, selective pedigrees of wide-shell type and plate-shell type, and hybrid pedigrees of middle-shell type are obtained. Finally, a comparation of the growth and development of Manila clam pedigrees from different geographical populations showed that the Manila clam pedigree from population of south China possesses the property of fast growth and high stress resistance (Yan Xiwu, 2002-2008; Zhang Yuehuan, 2005-2008).

At present, composite selection is generally applied in agriculture and animal husbandry, but rarely applied to aquatic animals. Wuhan Institute of Hydrobiology, Chinese Academy of Sciences adopted a selective breeding mode combining three characters of body color, body shape and scale in breeding carp; Institute of Oceanology, Chinese Academy of Sciences conducted a composite selection of shell colors and geographical populations in breeding Haliotis discus hannai and Argopectens irradias; and Yellow Sea Fisheries Research Institute, Chinese Academy of Fishery Sciences made atempt of multi-character composite selection in breeding Chinese shrimp.

There has been no report about composite selective mode of Manila clam. Chinese patent 200810011753.7, 20081001754.1, and 20081001751.8 disclosed the breeding method of selective pedigrees and cross pedigrees of Manila clam, based on single character.

### SUMMARY OF THE PRESENT INVENTION

An object of the present invention is to provide a Manila clam pedigree which possesses properties of fast growth and high stress resistance, wherein the properties have good genetic stability to pass down, in such a manner that the Manila clam pedigree is capable of being used widely in culture industry to take place of the present Manila clam pedigrees which grow slowly and can not resist high stress.

Another object of the present invention is to provide a process for breeding the Manila clam pedigree mentioned above, wherein the process provides an effective and operable way to obtain the Manila clam pedigree which grows fast and resists high stress.

Another object of the present invention is to provide a process for breeding the Manila clam pedigree mentioned above, wherein the process combines up shell shapes (quantitive character), geographical populations (genetic distance), shell colors (qualitative character) and economic character of present Manila clam pedigrees.

Another object of the present invention is to provide a process for breeding the Manila clam pedigree mentioned above, wherein the process breeds the Manila clam pedigree by composite selecting present Manila clam pedigrees having various properties.

Accordingly, in order to accomplish the above objects, the present invention provides a process for breeding a Manila clam pedigree, comprising:

directively breeding present Manila clam pedigrees having different shell shapes to obtain a shell shape pedigree (A) having best phenotypic character in the present Manila clam pedigrees;

directively breeding the shell shape pedigrees (A) from different geographical populations to obtain a geographical population pedigree (B) having best phenotypic character in the shell shape pedigrees (A);

directively breeding the geographical population pedigrees (B) having different shell colors to obtain at least a growth shell color pedigree (C) of fastest growth and at least a resistance shell color pedigrees (E) of highest stress resistance in the geographical population pedigrees (B);

hybridizing the growth shell color pedigree (C) and the resistance shell color pedigree (E) to obtain a first hybridied pedigree (F₁) having a character of faster growth and higher stress resistance than the present Manila clam pedigrees; and

directively breeding the first hybridied pedigree (F₁) to obtain a second hybridied pedigree (F₂) which maintain the character of faster growth and higher stress resistance than the present Manila clam pedigrees;

whereby the second hybridied pedigree (F₂) is the Manila clam pedigree which has the character of faster growth and higher stress resistance than the present Manila clam pedigrees, wherein the character has genetic stability to pass down, in such a manner that the second hybridied pedigree (F₂) is valuable in culture industry.

The present invention also provides a Manila clam pedigree of fast growth and high stress resistance bred according to the above process.

These and other objectives, features, and advantages of the present invention will become apparent from the following detailed description and the appended claims.

### DETAILED DESCRIPTION OF THE PREFERRED EMBODIMENT

According to a preferred embodiment of the present invention, a process for breeding a Manila clam pedigree is illustrated, comprising:

directively breeding present Manila clam pedigrees having different shell shapes to obtain a shell shape pedigree (A) having best phenotypic character (fastest growth and highest stress resistance) in the present Manila clam pedigrees;

directively breeding the shell shape pedigrees (A) from different geographical populations to obtain a geographical population pedigree (B) having best phenotypic character (fastest growth and highest stress resistance) in the shell shape pedigrees (A);

directively breeding the geographical population pedigrees (B) having different shell colors to obtain at least a growth shell color pedigree (C) of fastest growth and at least a resistance shell color pedigrees (E) of highest stress resistance in the geographical population pedigrees (B);

hybridizing the growth shell color pedigree (C) and the resistance shell color pedigree (E) to obtain a first hybridied pedigree (F₁) having a character of faster growth and higher stress resistance than the present Manila clam pedigrees; and

directively breeding the first hybridied pedigree (F₁) to obtain a second hybridied pedigree (F₂) which maintains the character of faster growth and higher stress resistance than the present Manila clam pedigrees;

whereby the second hybridied pedigree (F₂) is the Manila clam pedigree which has the character of faster growth and higher stress resistance than the present Manila clam pedigrees, wherein the character has genetic stability to pass down, in such a manner that the second hybridied pedigree (F₂) is valuable in culture industry.

The present invention is capable of obtaining several improved Manila clam pedigrees at a time. Particularly, directively breeding the geographical population pedigrees (B) having different shell colors to obtain two growth shell color pedigrees (C, D) of fastest growth and two resistance shell color pedigrees (E, F) of highest stress resistance in the geographical population pedigrees (B); and hybridizing the two growth shell color pedigrees (C, D) and the two resistance shell color pedigrees (E, F) by C×E, D×E, and F×E, to obtain three first hybridied pedigrees (F₁), wherein the first hybridied pedigrees (F₁) of C×E and D×E have the character of faster growth and higher stress resistance than the present Manila clam pedigrees, and the first hybridied pedigree (F₁) of F×E, has the character of higher stress resistance than the present Manila clam pedigrees.

The process according to the present invention takes full advantage of the polymorphism in widespreadness, shell colors and shell shapes of the Manila clam pedigrees to obtain new Manila clam pedigrees. The new Manila clam pedigrees comprise white zebra, red zebra and black zebra, and have stable genetic phenotypic character. The process improves the phenotypic character of the present Manila clam pedigrees, increases production of Manila clam, and also provides a steady base for developing improved varieties and upgrading pedigrees of Manila clam.

According to the present invention, the shell shapes of the present Manila clam pedigrees are classified into wild-shell (lunrula<70), middle-shell (70≦lunrula≦90), plate-shell (lunrula>90) according to the number of lunrula. By directive breeding Manila clam pedigrees of the three shell shapes from Dalian population, and comparing growth and development thereof, a conclusion is drawn that the Manila clam pedigree of middle-shell has a character of fastest growth and highest stress resistance among the three shell shapes.

Accordingly, the shell shape pedigree (A) preferably has a shell shape of middle-shell.

According to the present invention, by directively breeding Manila clam pedigrees of middle-shell from different geographical populations comprising south China, north China, Japan and Korea, and comparing growth and development thereof, a conclusion is drawn that the Manila clam pedigree from south China has a character of fastest growth and highest stress resistance among the four geographical polulations.

Accordingly, the geographical population pedigree (B) is preferably from south China.

According to the present invention, by directive breeding Manila clam pedigrees of different shell colors from south China, wherein the shell color strains comprise two-band red clam, two-band white clam, agate-black clam, ocean-red clam, pearl-white clam, zebra clam and wave clam, and comparing growth and development thereof, a conclusion is drawn that the Manila clam pedigrees of pearl-white clam and ocean-red clam have a character of fastest growth, and the Manila clam pedigrees of zebra clam and agate-black clam have a character of highest stress resistance among the shell colors.

Accordingly, the two growth shell color pedigrees (C, D) preferably have shell color strains of pearl-white clam and ocean-red clam respectively, and the two resistance shell color pedigrees (E, F) preferably have shell colors of zebra clam and agate-black clam respectively.

According to the present invention, by hybridizing the Manila clam pedigrees of pearl-white clam, ocean-red clam and agate-black clam with the Manila clam pedigree of zebra clam respectively in individual, hybrid Manila clam pedigrees thereof are found to have hybrid vigor. The hybrid Manila clam pedigrees have shell colors of white zebra, red zebra and black zebra. The shell colors are consistent in reciprocal crosses, which indicates that the shell color has no relationship with sex, therefore has no sex-linked inheritance. Based on the conclusion of no sex-linked inheritance, hybridizing the Manila clam pedigrees of pearl-white clam, ocean-red clam and agate-black clam with the Manila clam pedigree of zebra clam respectively in population to obtain plenty offsprings of white zebra clam, red zebra clam and black zebra clam.

Accordingly, the resistance shell color pedigree (E) preferably has shell color of zebra, and the first hybridied pedigrees (F₁) preferably have color strains of white zebra clam, red zebra clam and black zebra clam respectively.

According to the present invention, adopting the first hybridied pedigrees (F₁) of white zebra, red zebra and black zebra as parents, and then directively breeding to obtain the second hybridied pedigrees (F₂). The second hybridied pedigrees (F₂) have colors of white zebra, red zebra and black zebra respectively. It is observed that the second hybridied pedigrees (F₂) do not lose the shell colors, and the properties of growth and stress resistance maintain highly consistent with the first hybridied pedigrees (F₁). Therefore Manila clam pedigrees having good characters and genetic stability are obtained finally.

The shell colors of the Manila clam pedigrees are defined by three features consisting of radial bands, background colors and shell patterns. The radial bands comprise two-band red clam and two-band white clam; the background colors comprise agate-black clam, ocean-red clam and pearl-white clam; and the shell patterns comprise zebra clam and wave clam.

The process further comprises identifying a sex of the two growth shell color pedigrees (C, D) and the two resistance shell color pedigrees (E, F) before hybridizing to obtain the first hybridied pedigrees (F₁).

Identifying a sex of a Manila clam pedigree comprises: locating a gonad position of the Manila clam pedigree; drilling on a shell thereof to reach to the gonad position; picking out sperms or eggs with a disinfected microsyringe; adding the sperms or eggs into seawater; and observing under microscope. The eggs diffuse in the seawater, and look round or pear under microscope; while the sperms look like smog in the seawater, and look like tadpole under microscope. Preferably, the present invention adopts an electric drill whose diameter is 0.6 mm.

The present invention also provides a Manila clam pedigree bred according to the above process.

### EXAMPLE 1

Step 1: in 2002˜May, 2003, classifying Manila clam pedigrees into wide-shell type (lunrula<70), middle-shell type(70≦lunrula≦90), and plate-shell type(lunrula>90) according to the number of lunrula. In Dalian Hailiang Fishery and Food Limited Company, establishing self-fertilized lines of different shell shapes from Dalian population, and comparing growth and development thereof. The shell shapes comprise wide-shell type, middle-shell type, and plate-shell type. After measuring for two generations, the plate-shell pedigree has properties of fast growth and high stress resistance.

Step 2: in 2003˜June, 2004, based on the step 1, comparing growth and development of Manila clam pedigrees of plate-shell type from different geographical populations and directive breeding. The geographical populations comprise southern China Putian population, northern China Dalian population and Korea Pusan population. After measuring for two generations, the pedigree from southern China Putian population has properties of fast growth and high stress resistance.

Step 3: in 2005˜September, 2008, based on the step 2, comparing growth and development of Manila clam pedigrees of different shell color strains from southern China Putian population. The shell color strains comprise two-band red clam, two-band white clam, agate-black clam, ocean-red clam, pearl-white clam, zebra clam, and wave clam. After measuring for three generations, the pearl white pedigree and ocean red pedigree have property of fast growth, and the zebra pedigree and agate black pedigree have property of high stress resistance.

Step 4: in 2005˜September, 2008, based on the step 3, by hybridizing the Manila clam pedigrees of pearl-white clam, ocean-red clam and agate-black clam with the Manila clam pedigree of zebra clam respectively in individual, hybrid Manila clam pedigrees thereof are found to have hybrid vigor. The hybrid Manila clam pedigrees have shell colors of white zebra clam, red zebra clam and black zebra clam. The shell colors are consistent in reciprocal crosses, which indicates that the shell color has no relationship with sex, therefore has no sex-linked inheritance. Based on the conclusion of no sex-linked inheritance, hybridizing the Manila clam pedigrees of pearl-white clam, ocean-red clam and agate-black clam with the Manila clam pedigree of zebra clam respectively in population to obtain plenty of white zebra, red zebra and black zebra offsprings.

Step 5, in 2005˜September, 2008, based on the step 4, adopting the first hybridied pedigrees (F₁) of white zebra clam, red zebra clam and black zebra clam as parents, and then directive breeding to obtain the second hybridied pedigrees (F₂). The second hybridied pedigrees (F₂) have colors of white zebra clam, red zebra clam and black zebra clam respectively. It is observed that the second hybridied pedigrees (F₂) do not lose the shell colors, and the properties of growth and stress resistance maintain highly consistent with the first hybridied pedigrees (F₁). Therefore Manila clam pedigrees having good characters and genetic stability are obtained finally.

In the Manila clam pedigrees by composite selecting according to the above steps, growth speed of the white zebra pedigree increases 20˜30%, and survival rate thereof increases 150˜250%; growth speed of the red zebra pedigree increases 20˜25%, and survival rate thereof increases 100˜200%; and survival rate of the black zebra increases 360˜720%.

### EXAMPLE 2

Step 1: in 2002˜May, 2003, classifying Manila clam pedigrees into wide-shell type(lunrula<70), middle-shell type(70≦lunrula≦90), and plate-shell type(lunrula>90) according to the number of lunrula. Comparing growth and development of Manila clam pedigrees of different shell shapes from Dalian population. The shell shapes comprise wide-shell type, middle-shell type, and plate-shell type. After measuring for two generations, the plate-shell pedigree has properties of fast growth and high stress resistance.

Step 2: in 2004˜July, 2005, based on the step 1, comparing growth and development of Manila clam pedigrees of plate-shell type from different geographical populations and directively breeding. The geographical populations comprise southern China Putian population, northern China Dalian population and Japan Tokyo population. After measuring for two generations, the pedigree from southern China Putian population has properties of fast growth and high stress resistance.

Step 3: in 2003˜September, 2005, based on the step 2, comparing growth and development of Manila clam pedigrees of different shell colors from southern China Putian population. The shell color strains comprise two-band red clam, two-band white clam, ocean-red clam, pearl-white clam, zebra clam and wave clam. After measuring for three generations, the pearl-white pedigree and ocean-red pedigree have property of fast growth, and the zebra pedigree has property of high stress resistance.

Step 4: in 2005˜September, 2008, based on the step 3, by hybridizing the Manila clam pedigrees of pearl-white clam and ocean-red clam with the Manila clam pedigree of zebra clam respectively in individual, hybrid Manila clam pedigrees thereof are found to have hybrid vigor. The hybrid Manila clam pedigrees have shell colors of white zebra and red zebra. The shell colors are consistent in reciprocal crosses, which indicates that the shell color has no relationship with sex, therefore has no sex-linked inheritance. Based on the conclusion of no sex-linked inheritance, hybridizing the Manila clam pedigrees of pearl-white clam and ocean-red clam with the Manila clam pedigree of zebra clam respectively in population to obtain plenty of white zebra and red zebra offsprings.

Step 5, in 2007˜September, 2008, based on the step 4, adopting the first hybridied pedigrees (F₁) of white zebra clam and red zebra clam as parents, and then directive breeding to obtain the second hybridied pedigrees (F₂). The second hybridied pedigrees (F₂) have colors of white zebra and red zebra respectively. It is observed that the second hybridied pedigrees (F₂) do not lose the shell colors, and the properties of growth and stress resistance maintain highly consistent with the first hybridied pedigrees (F₁). Therefore a Manila clam pedigree having good characters and genetic stability is obtained finally.

In the Manila clam pedigrees by composite selecting according to the above steps, growth speed of the white zebra pedigree increases 20˜25%, and survival rate thereof increases 120˜240%; and growth speed of the red zebra pedigree increases 15˜20%, and survival rate thereof increases 90˜180%.

One skilled in the art will understand that the embodiment of the present invention as described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A process for breeding a Manila clam pedigree, comprising:
directively breeding present Manila clam pedigrees having different shell shapes to obtain a shell shape pedigree (A) of fastest growth and highest stress resistance in the present Manila clam pedigrees;
directively breeding the shell shape pedigrees (A) from different geographical populations to obtain a geographical population pedigree (B) of fastest growth and highest stress resistance in the shell shape pedigree (A);
directively breeding the geographical population pedigrees (B) having different shell colors to obtain at least a growth shell color pedigree (C) of fastest growth and at least a resistance shell color pedigree (E) of highest stress resistance in the geographical population pedigrees (B);
hybridizing the growth shell color pedigree (C) and the resistance shell color pedigree (E) to obtain a first hybridized pedigree (F₁) having a character of faster growth and higher stress resistance than the present Manila clam pedigrees; and
directively breeding the first hybridized pedigree (F₁) to obtain a second hybridized pedigree (F₂) which maintains the character of faster growth and higher stress resistance than the present Manila clam pedigrees, therefore has genetic stability.

2. The process, as recited in claim 1, wherein particularly, directively breeding the geographical population pedigrees (B) having different shell colors to obtain two growth shell color pedigrees (C, D) of fastest growth and two resistance shell color pedigrees (E, F) of highest stress resistance in the geographical population pedigrees (B); and hybridizing the two growth shell color pedigrees (C, D) and the two resistance shell color pedigrees (E, F) by C×E, D×E, and F×E, to obtain three first hybridied pedigrees (F₁), wherein the first hybridied pedigrees (F₁) of C×E and D×E have the character of faster growth and higher stress resistance than the present Manila clam pedigrees, and the first hybridied pedigree (F₁) of F×E, has the character of higher stress resistance than the present Manila clam pedigrees.

3. The process, as recited in claim 1, wherein the shell shape pedigree (A) has a shell shape of middle-shell type.

4. The process, as recited in claim 2, wherein the shell shape pedigree (A) has a shell shape of middle-shell type.

5. The process, as recited in claim 1, wherein the geographical population pedigree (B) is from south China.

6. The process, as recited in claim 2, wherein the geographical population pedigree (B) is from south China.

7. The process, as recited in claim 4, wherein the geographical population pedigree (B) is from south China.

8. The process, as recited in claim 2, wherein the two growth shell color pedigrees (C, D) have shell colors of pearl-white clam and ocean-red clam respectively, and the two resistance shell color pedigrees (E, F) have shell colors of zebra clam and agate-black clam respectively.

9. The process, as recited in claim 4, wherein the two growth shell color pedigrees (C, D) have shell colors of pearl-white clam and ocean-red clam respectively, and the two resistance shell color pedigrees (E, F) have shell colors of zebra clam and agate-black clam respectively.

10. The process, as recited in claim 7, wherein the two growth shell color pedigrees (C, D) have shell colors of pearl-white clam and ocean-red clam respectively, and the two resistance shell color pedigrees (E, F) have shell colors of zebra clam and agate-black clam respectively.

11. The process, as recited in claim 2, wherein the resistance shell color pedigree (E) has shell color of zebra, and the first hybridied pedigrees (F₁) have colors of white zebra, red zebra and black zebra respectively.

12. The process, as recited in claim 4, wherein the resistance shell color pedigree (E) has shell color of zebra, and the first hybridied pedigrees (F₁) have colors of white zebra, red zebra and black zebra respectively.

13. The process, as recited in claim 7, wherein the resistance shell color pedigree (E) has shell color of zebra, and the first hybridied pedigrees (F₁) have colors of white zebra, red zebra and black zebra respectively.

14. The process, as recited in claim 10, wherein the resistance shell color pedigree (E) has shell color of zebra, and the first hybridied pedigrees (F₁) have colors of white zebra, red zebra and black zebra respectively.

15. The process, as recited in claim 2, further comprising identifying a sex of the two growth shell color pedigrees (C, D) and the two resistance shell color pedigrees (E, F) before hybridizing to obtain the first hybridied pedigrees (F₁).

16. The process, as recited in claim 4, further comprising identifying a sex of the two growth shell color pedigrees (C, D) and the two resistance shell color pedigrees (E, F) before hybridizing to obtain the first hybridied pedigrees (F₁).

17. The process, as recited in claim 7, further comprising identifying a sex of the two growth shell color pedigrees (C, D) and the two resistance shell color pedigrees (E, F) before hybridizing to obtain the first hybridied pedigrees (F₁).

18. A Manila clam pedigree, bred by a process comprising:
directively breeding present Manila clam pedigrees having different shell shapes to obtain a shell shape pedigree (A) of fastest growth and highest stress resistance in the present Manila clam pedigrees;
directively breeding the shell shape pedigrees (A) from different geographical populations to obtain a geographical population pedigree (B) of fastest growth and highest stress resistance in the shell shape pedigree (A);
directively breeding the geographical population pedigrees (B) having different shell colors to obtain at least a growth shell color pedigree (C) of fastest growth and at least a resistance shell color pedigree (E) of highest stress resistance in the geographical population pedigrees (B);
hybridizing the growth shell color pedigree (C) and the resistance shell color pedigree (E) to obtain a first hybridized pedigree (F₁) having a character of faster growth and higher stress resistance than the present Manila clam pedigrees; and
directively breeding the first hybridized pedigree (F₁) to obtain a second hybridized pedigree (F₂) which maintains the character of faster growth and higher stress resistance than the present Manila clam pedigrees, therefore has genetic stability.

19. The Manila clam pedigree, as recited in claim 18, wherein particularly, directively breeding the geographical population pedigrees (B) having different shell colors to obtain two growth shell color pedigree (C, D) of fastest growth and two resistance shell color pedigree (E, F) of highest stress resistance in the geographical population pedigrees (B); and hybridizing the two growth shell color pedigrees (C, D) and the two resistance shell color pedigrees (E, F) by C×E, D×E, and F×E, to obtain three first hybridied pedigrees (F₁), wherein the first hybridied pedigrees (F₁) of C×E and D×E have the character of faster growth and higher stress resistance than the present Manila clam pedigrees, and the first hybridied pedigree (F₁) of F×E, has the character of higher stress resistance than the present Manila clam pedigrees.

20. The Manila clam pedigree, as recited in claim 19, wherein the shell shape pedigree (A) has a shell shape of middle-shell type, the geographical population pedigree (B) is from south China, and the two growth shell color pedigrees (C, D) have shell color strains of pearl-white clam and ocean-red clam respectively, and the two resistance shell color pedigrees (E, F) have shell color strains of zebra clam and agate-black clam respectively.
